(19) United States
(12) Patent Application Publication
(10) Pub. No.: US 2007/0146522 A1
(43) Pub. Date: Jun. 28, 2007

(54) Driving method for solid-state image pickup device and image pickup apparatus

(75) Inventors: Yoshihiro Okada, Hashima-shi (JP); Kazutaka Itsumi, Kuwana-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., MORIGUCHI-SHI (JP)

(21) Appl. No.: 11/642,642

(22) Filed: Dec. 21, 2006

(30) Foreign Application Priority Data
Dec. 27, 2005 (JP) 2005-375140

(51) Int. Cl. H04N 5/335

(52) U.S. Cl. 348/311

(57) ABSTRACT

S/N ratio deterioration resulting from dark current generated in each light-receiving pixel is suppressed in a frame transfer CCD image sensor. A predetermined off-voltage V_{L2} is applied to a transfer electrode before an on-voltage V_{H} is applied to the transfer electrode to form a potential well and to start the accumulation of information charges into the potential well during an exposure period. The off-voltage V_{L2} is set to be lower than the off-voltage V_{L1} of the transfer clock signal during a frame transfer (period: t18 to t19). The off-voltage V_{L2} is set at the pinning voltage, for example. As the result of applying the off-voltage V_{L2}, holes are captured at the interface state in the surface region of the semiconductor substrate, thereby making it difficult for the thermally excited electrons to jump from the valence band to the conduction band.

### CROSS-REFERENCE TO RELATED APPLICATION

The priority application number JP2005-375140 upon which this patent application is based is hereby incorporated by reference.

### FIELD OF THE INVENTION

The present invention relates to a solid-state image pickup device for generating information charges by receiving light by CCD shift registers, and more particularly, to technology for suppressing dark current that is generated during an exposure period.

### BACKGROUND OF THE INVENTION

A frame transfer CCD image sensor includes an image pickup section for generating and accumulating information charges for each pixel in response to light exposure, and a light-shielded storage section for storing the information charges that are received from the image pickup section at high speed until the information charges are read out line by line by a horizontal transfer section.

The image pickup section and the storage section each include a plurality of vertical CCD shift registers containing a plurality of charge transfer channel regions extended vertically being arranged parallel to one another, and a plurality of transfer electrodes extended horizontally being arranged parallel to one another. Each bit of the CCD shift register includes a plurality of transfer electrodes located adjacent to one another, and forms at each charge-transfer channel region one potential well for storing information charges as a result of voltage applied to the transfer electrodes. Each bit of the CCD shift register of the image pickup section forms a pixel of the image pickup device, and receives light from an object to be photographed, generating information charges depending on an amount of received light, and accumulating the information charges in the potential well.

FIG. 1 is a timing chart showing in schematic form clock signals that a conventional driving circuit applies to the frame transfer CCD image sensor. In FIG. 1, the axis of abscissa represents time. The image pickup section and the storage section are of the three-phase driving type. Three-phase clock signals φi1 to φi3 are applied to three transfer electrodes, which are located adjacent to one another on each of the pixels of the image pickup section. The driving circuit generates clock signals each switching between two different voltage states, on-voltage V_{H} and off-voltage V_{L} (V_{H}>V_{L}), and applies them to each of the transfer electrodes of the CCD shift registers forming each of the image pickup section and the storage section.

The driving circuit forms a potential well under the transfer electrode applied with clock signal φi2, which is set at the on-voltage V_{H}, and accumulates the information charges caused by light exposure in the potential well. At the same time, the driving circuit sets the clock signals φi1 and φi3 to be applied to the adjacent transfer electrodes at the voltage V_{L} to form a potential barrier between the potential wells, thereby enabling information charges to be accumulated at each pixel. An exposure period E starts after an electronic shutter operation (at time t01), and terminates when a frame transfer starts (time t02). The electronic shutter operation is performed in such a manner that the clock signals φi1 to φi3 to be applied to the transfer electrodes of the image pickup section are set at the off-voltage, and a pulse 2 of a voltage V_{SH}, which is higher than in a normal state, is generated as a substrate voltage Vsub, whereby information charges stored in the potential well of the image pickup section are discharged to the substrate.

In the frame transfer from the image pickup section to the storage section and the line transfer from the storage section to the horizontal transfer part, the driving circuit applies transfer clock signals 4 and 6, which are periodically switched between the on-voltage V_{H} and the off-voltage V_{L}, to the transfer electrodes. The transfer clock signals 4 and 6 applied to the adjacent transfer electrodes are shifted from one another to move the potential well in a fixed direction. Transfer clock signals φs1 to φs3 are basically the same except that their phases are different from one another. Hence, only the transfer clock signal φs1 is typically illustrated in FIG. 1.

In the charge transfer channel region, dark current occurs, for example, due to the effect of an interface state in the vicinity of a surface of a semiconductor substrate. The potential well formed during the exposure period accumulates not only information charges produced in correspondence with an incident ray but also dark current generated at a corresponding region. The dark current is one of the factors causing deterioration of the S/N ratio.

### SUMMARY OF THE INVENTION

Accordingly, the present invention provides a driving method for a solid-state image pickup device which provides an image having an improved S/N ratio by reducing the dark current mixed into the information charges accumulated in the CCD shift registers in the image pickup section during the exposure period, and an image pickup apparatus which also provides an image of an S/N ratio improved in the same way.

The driving method for a solid-state image pickup device, according to the present invention, is applied to a solid-state image pickup device having an image pickup section, containing CCD shift registers, in which the CCD shift registers receive light and accumulate the information charges generated in response to the received light into the potential wells of the CCD shift registers. The driving method includes an exposure process for accumulating the information charges generated in response to the received light into each potential well, and a transfer process for driving the CCD shift registers with transfer clocks applied to read out the information charges from the image pickup section. The exposure process includes a accumulation process for applying an on-voltage to a storage electrode of transfer electrodes of the CCD shift registers, the storage electrode being one of the transfer electrodes and located corresponding to the accumulation position of the information charges to thereby form the potential well, and a pre-accumulation process for applying a pre-accumulation off-voltage, lower than an off-voltage of the transfer clock signal, to the storage electrode prior to the accumulation process.

An image pickup apparatus according to the present invention has a solid-state image pickup device including an image pickup section, containing CCD shift registers, in which the CCD shift registers receive light and accumulate the information charges generated in response to the received light into the potential wells of the CCD shift registers, and a driving circuit for generating an on-voltage and off-voltages to be applied to the transfer electrodes of the CCD shift registers and controlling the formation and the shift of the potential well. The driving circuit generates an exposure off-voltage, which is lower than the off-voltage in a transfer operation for reading out the information charges from the image pickup section by driving the CCD shift registers for transfer, as the off-voltage in an exposure operation for accumulating the information charges generated in response to the received light into the potential well. In the exposure operation, the driving circuit applies the exposure off-voltage to the transfer electrode prior to applying the on-voltage to the transfer electrode to form the potential well.

### BRIEF DESCRIPTION OF THE DRAWINGS

FIG. 1 is a timing chart showing in model form clock signals that a conventional driving circuit applies to the frame transfer CCD image sensor;

FIG. 2 is a block diagram showing a configuration of an image pickup apparatus according to an embodiment of the present invention;

FIG. 3 is a plan view schematically showing a part of the image pickup section 10i;

FIG. 4 is a cross sectional view taken along in a charge transfer direction of the CCD shift register of the image pickup section;

FIG. 5 is a graph showing potential profiles in the CCD shift register shown in FIG. 4 as viewed in the depth direction; and

FIG. 6 is a timing chart showing basic shifts of various voltage signals that the clock generation circuit supplies to the image sensor.

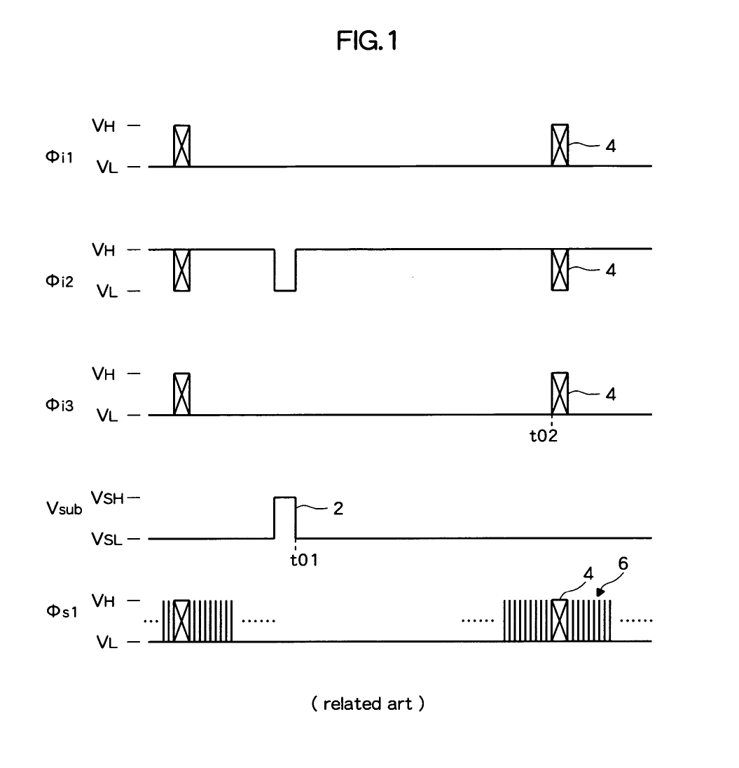

### DESCRIPTION OF THE PREFERRED EMBODIMENTS

The preferred embodiments of the present invention will be described with reference to the accompanying drawings.

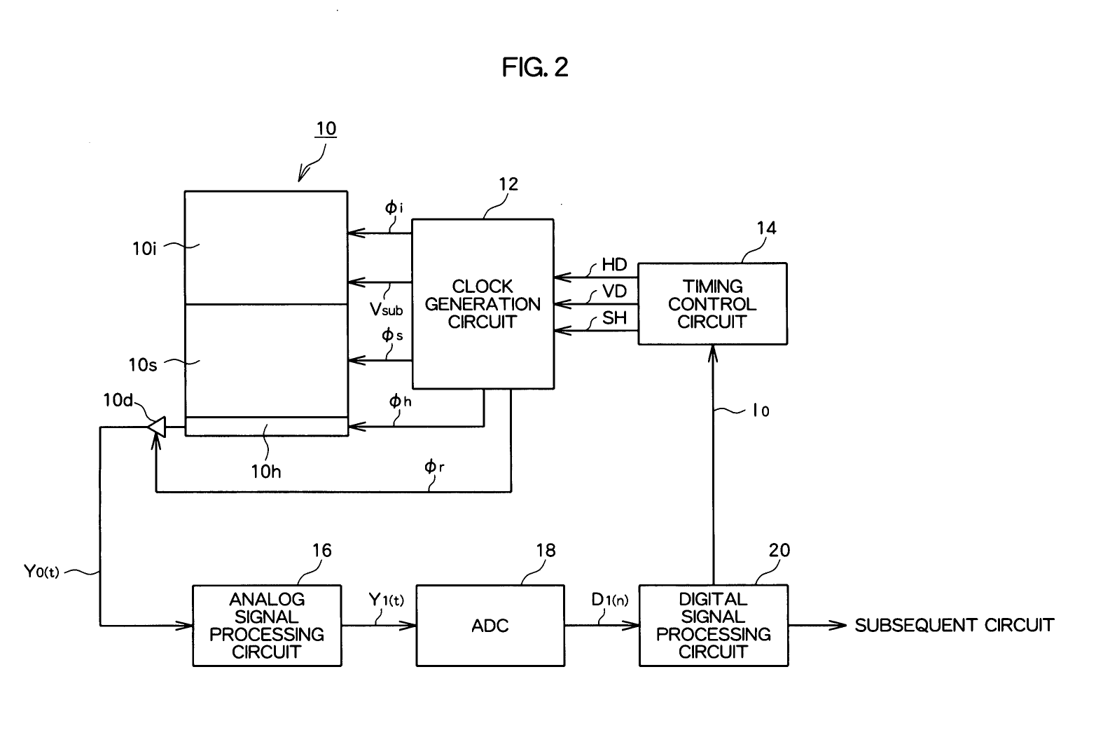

FIG. 2 is a block diagram showing a configuration of an image pickup apparatus according to an embodiment of the present invention. The image pickup apparatus is made up of an image sensor 10, a clock signal circuit 12, a timing control circuit 14, an analog signal processing circuit 16, an A/D converter circuit 18, and a digital signal processing circuit 20.

The image sensor 10 is a frame transfer CCD image sensor and includes an image pickup section 10i, a storage section 10s, a horizontal transfer section 10h and an output section 10d, all formed on a surface of a semiconductor substrate. Each of the imaging section 10i and the storage section 10s has a plurality of vertical CCD shift registers arranged in a line direction (a horizontal direction of an image). Each of the vertical CCD shift registers of the imaging section 10i and each of the vertical CCD shift registers of the storage section 10s are arranged in a column direction and have a consecutive channel. Those vertical CCD shift registers are provided with a plurality of gate electrodes as transfer electrodes, which extend on the substrate in the line direction and arranged parallel to one another and in the column direction. By applying clock signals of plural phases, which are shifted from one another, to those charge transfer electrodes, information charge of each pixel is vertically transferred through the vertical CCD shift registers. In the image sensor 10, the CCD shift registers of the image pickup section 10i and the storage section 10s are of the three-phase driving type. The image pickup section 10i is supplied with a three-phase clock φi and the storage section 10s is supplied with a three-phase clock φs, whereby storage and transfer of the information charges are respectively controlled.

Light receiving pixels formed with the bits of the vertical CCD shift registers of the image pickup section 10i generate charge according to incident light, and accumulate signal charges. The information charge accumulating operation in the image pickup section 10i will be subsequently described. After a predetermined period of exposure time elapses, the vertical CCD shift registers of the image pickup section 10i and the storage section 10s are driven by the three-phase clock signals φi and φs, and the frame transfer from the image pickup section 10i to the storage section 10s is performed. The storage section 10s is covered with a shielding film to prevent charge generation by incident light. Accordingly, the storage section 10s is able to store the signal charges frame transferred from the image pickup section 10i. The horizontal transfer section 10h is a CCD shift register having bits respectively coupled to the output terminals of the vertical CCD shift registers of the storage section 10s. The signal charges of one screen, stored in the storage section 10s, are line transferred to the horizontal transfer section 10h line by line. The signal charges, which have reached the horizontal transfer section 10h, are transferred to the output section 10d by the horizontal transfer driving of the horizontal transfer section 10h. The output section 10d includes an electrically isolated capacitor and an amplifier for extracting a potential change of the capacitor. The output section 10d receives the signal charge received from the horizontal transfer section 10h via the capacitor bit by bit, converts it into a voltage value, and outputs the voltage value in the form of a time sequential image signal Y0 (t).

The clock generation circuit 12 generates a clock φi for driving the vertical shift register of the image pickup section 10i, a clock φs for driving the vertical shift register of the storage section 10s, a clock φh for driving the horizontal transfer section 10h, a clock φr for driving a reset gate of the output section 10d and a substrate voltage Vsub to be applied to an n-type semiconductor substrate, thereby driving the image sensor 10. The clock generation circuit 12 operates according to timing signals supplied from the timing control circuit 14.

The timing control circuit 14 comprises a plurality of counters, each for counting a reference clock signal CK with a constant cycle, and dividing a reference clock signal CK to generate timing signals such as a horizontal synchronizing signal HD and a vertical synchronizing signal VD.

The analog signal processing circuit 16 applies processes of sample and hold, AGC (automatic gain control), etc. to the image signal Y0 (t) to generate an image signal Y1 (t) having a given format.

The A/D (analog-to-digital) converter 18 converts an analog image signal Y1 (t), which comes from the analog signal processing circuit 16, into a digital signal, and outputs the converted signal as image data D1 (n).

The digital signal processing circuit 20 receives the image data D1 (n) from the A/D converter circuit 18 and variously processes the image data D1 (n). For example, the digital signal processing circuit 20 generates luminance data and color data from the image data D1 (n), and processes the generated data for contour correction and gamma correction. The digital signal processing circuit 20 contains an automatic exposure control circuit, and integrates the image data for each screen, and enlarges and reduces an exposure period E according to the resultant integrated value. The automatic exposure control circuit designates an exposure period E by using an exposure control value Io with a horizontal scanning period (1H) as a unit.

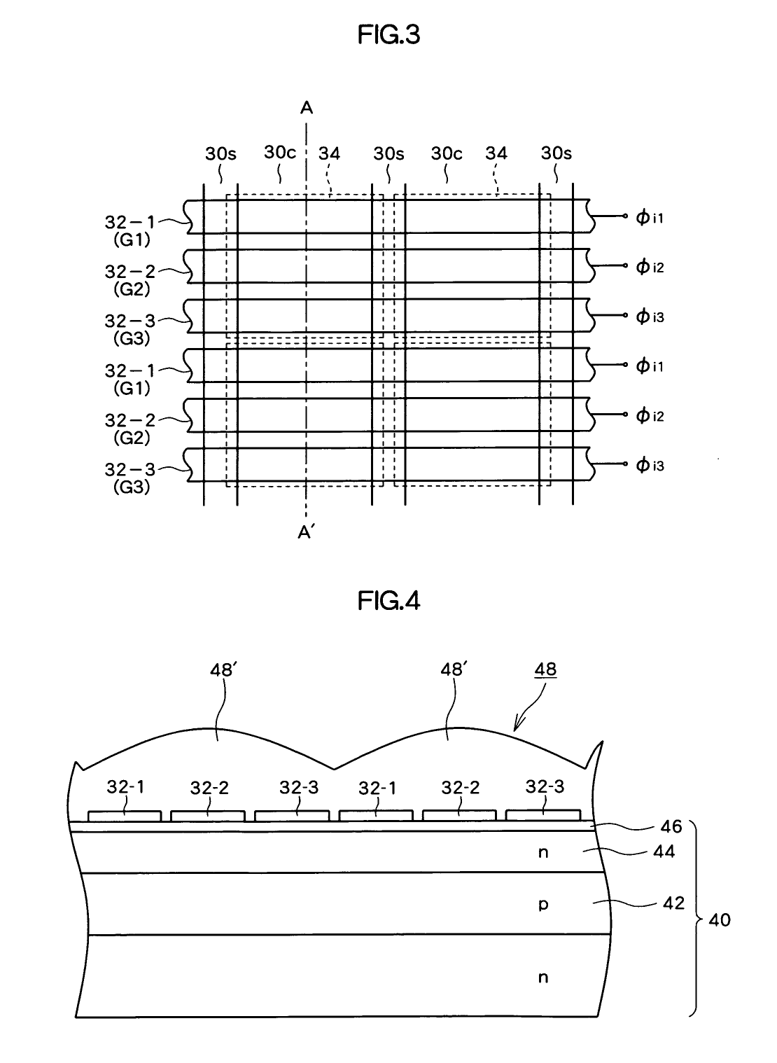

FIG. 3 is a plan view schematically showing a part of the image pickup section 10i. The light receiving pixels respectively correspond to the bits of the vertical shift registers and are capable of accumulating information charge of one pixel. Channel stop regions 30s separate channel regions 30c of the vertical shift registers. Transfer electrodes G1 to G3 (transfer electrodes 32-1 to 32-3) are periodically arranged in the column direction on the channel regions 30c extending in the column direction. A trio of transfer electrodes 32-1 to 32-3 are arranged on each of the light receiving pixels 34. The transfer electrode 32-2 is located on the central part of the pixel. The transfer electrodes 32-1 to 32-3 receive the clock signals φi1 to φi3 from the clock generation circuit 12.

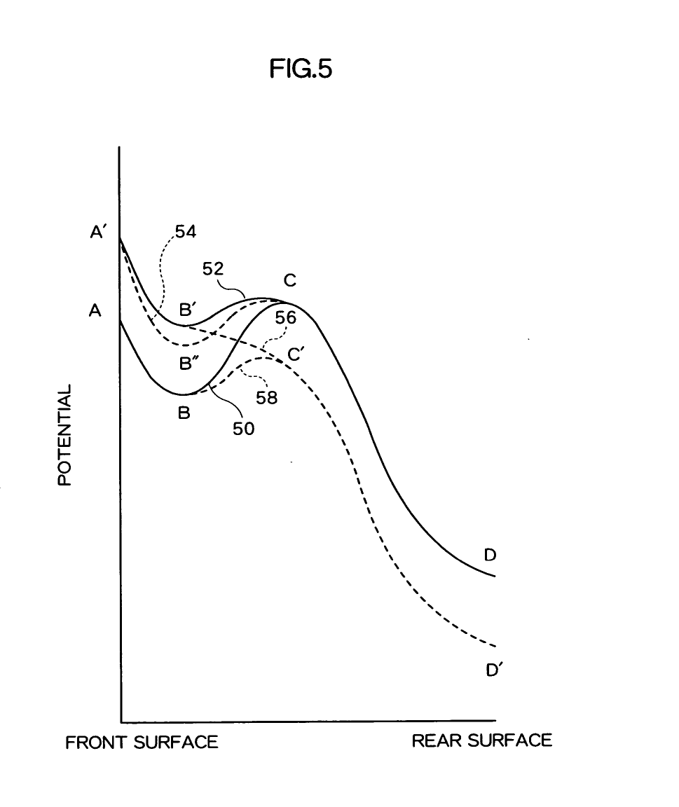

FIG. 4 is a cross sectional view taken on line A-A′ in FIG. 3. More precisely in the drawing, the image pickup section 10i is cut in the charge transfer direction of the CCD shift register. An n-type semiconductor substrate 40 is used, for example. A p-well 42 is formed by diffusing p-type impurities into the n-type semiconductor substrate 40. An n-well 44 is formed by diffusing n-type impurities into the n-type semiconductor substrate 40 to a depth level that is lower or shallower than the p-well 42. As a result, the CCD shift register becomes a buried channel CCD. Further, the n-well 44 and the p-well 42 form an npn structure in the depth direction in the semiconductor substrate 40, thereby forming a vertical overflow drain (VOD). The transfer electrodes 32-1 to 32-3 are formed on a surface of the substrate in a state that a gate oxide film 46 being inter layered between the transfer electrodes and the substrate surface. As described above, the three-phase clock signals φ1 to φ3 are applied to the transfer electrodes 32-1 to 32-3. The channel potential within the semiconductor substrate under the gate oxide film 46 is controlled by the clock voltages. A microlens array 48 is also illustrated in FIG. 4. Lens elements 48′, which form the microlens array 48, are located corresponding in position to the light receiving pixels, and collects the rays of light incident on the lens elements 48′ toward the light receiving pixels.

FIG. 5 is a graph showing potential profiles in the CCD shift register shown in FIG. 4, as viewed in the substrate depth direction. In the figure, the abscissa represents a depth of the semiconductor substrate, while the ordinate represents potential in the semiconductor substrate. In the figure, the downward direction is a positive potential direction and the upward direction is a negative potential direction. A curve 50 (curve ABCD) and a curve 52 (curve A′B′CD) represent potential profiles when one of the transfer electrodes 32 for one pixel is an on-electrode to which an on-voltage of a transfer clock signal is applied, and the remaining two transfer electrodes are off-electrodes to which an off-voltage of a transfer clock signal is applied. More simply, the curve 50 (curve ABCD) represents a potential profile under the on-electrode, and the curve 52 (curve A′B′CD) represents a potential profile under the off-electrodes. A point B on the curve 50 indicates an electrical potential of the potential well. A point B′ on the curve 52 indicates a potential at a saddle point of a potential barrier formed between the potential wells. A curve 54 (curve A′B″CD) indicates a potential profile under the off-electrodes during the shift of the potential well. During the shift of the potential well, two transfer electrodes 32 of each pixel are on-electrodes, and the remaining one transfer electrode 32 is the off-electrode. Accordingly, the short channel effect acts, and a potential at a point B″ is affected by the potential of the potential well under the on-electrodes on both sides, becoming deeper than of a point B′.

In FIG. 5, a curve 56 (curve A′B′C′D′), indicated by a dotted line, indicates a potential profile during an electronic shutter operation. In the electronic shutter operation, an off-voltage is applied to all the transfer electrodes of the image pickup section, and the substrate voltage Vsub is set at a positive voltage (point D′), higher than a normal voltage (point D). When the substrate voltage Vsub is increased, a potential of the p-well 42, which is normally located at a point C, lowers to a point C′, whereby a potential barrier existing in the substrate depth direction, formed by the p-well 42, disappears. As a result, it is possible for the information charges on the front surface of the substrate to move over the p-well 42 to the rear surface thereof.

As subsequently described, in the instant image pickup apparatus, a blooming suppression operation for discharging information charges is performed in order to suppressing blooming. In the blooming suppression operation, the substrate voltage Vsub is set at a positive voltage (point D′), higher than the normal voltage (point D), in a state where the on-voltage is applied to the transfer electrode corresponding to the potential well for storing the information charges. A potential profile under the on-electrode during the blooming suppressing operation is depicted as a curve 58 (ABC′D′), and a potential profile under the off-electrode is as a curve 56 (A′B′C′D′). Accordingly, of the information charges stored in the potential well, an amount of information charge exceeding a potential (point C′) of the p-well 42 is discharged to the rear surface of the substrate. The substrate voltage Vsub is selected to deepen the potential (point C′) of the p-well 42 beyond a point B″. Thus, the amount of information charge stored in the potential well is reduced to be below a potential barrier (point B″) under the off-electrode during the shifting of the potential well before the potential well shifts. As a result of this unique technical idea of the invention, it is difficult for blooming to occur.

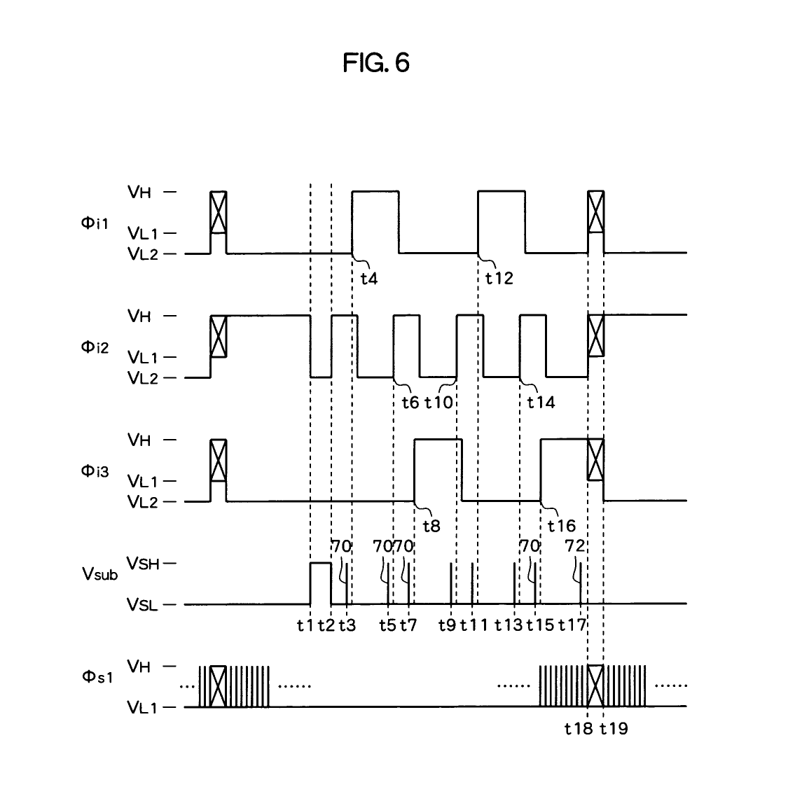

A method of driving the image sensor in the image pickup apparatus will now be described. FIG. 6 is a timing chart showing basic shifts of various voltage signals that the clock generation circuit 12 supplies to the image sensor 10. In FIG. 6, the axis of abscissa represents time. On the ordinate axis in FIG. 6, the voltage increases in amplitude in an upward direction. FIG. 8 illustrates in schematic form the waveforms and generation timings of the transfer clock signals φi1 to φi3 to be applied to the transfer electrodes of the image pickup section 10i, substrate voltage signal Vsub, and the transfer clock signal φs1 to be applied to the storage section 10s. The remaining transfer clock signals φs2 and φs3 are omitted from the figure since those signals are substantially the same as the transfer clock signal φs1 except that the phases of the φs2 and φs3 are different from that of φs1.

In the image pickup device, the off-voltage of the clock signal φi, which is applied to the transfer electrodes of the CCD shift registers of the image pickup section 10i, is set at voltage V_{L1} in the frame transfer operation, and at voltage V_{L2}, lower than the voltage V_{L1} in the exposure operation. The off-voltage V_{L1} may be set to be equal to the off-voltage of the transfer clock signal φs to the CCD shift registers of the storage section 10s. The voltage V_{L2} is set at, for example, a voltage for pinning the potential on the substrate surface under the transfer electrode to which that voltage is applied. An inversion layer in which holes supplied from the channel stop regions 30s are accumulated is provided on the substrate surface in a pinning state. In a state where the substrate surface is inverted by the holes, generation of the thermally excited electrons is suppressed in an interface region where it contacts the gate oxide film. Since, for example, a density of free holes in a valence band is large at the inverted interface, the rate at which the interface state produced at an interface between the substrate and the gate oxide film captures the holes becomes higher electrons that have been excited from the valence band to a surface state capture holes and easily return to the valence band. As in this pinned state, electrons are difficult to excite into the conduction band under the transfer electrode to which a negative off-voltage is applied, and hence the dark current based on the interface state is suppressed.

In the image pickup apparatus, the accumulation position of the information charges is shifted in each pixel during the exposure period. For example, within a trio of transfer electrodes A1 to G3 located on each light receiving pixel 34 (FIG. 3), a position of the potential well, which is formed under the driven transfer electrode, is shifted in the order of the transfer electrodes G2, G1, G2, G3, G2. Through the shift of the potential well during the exposure period, the dark currents within each pixel are positionally averaged to suppress variations of the dark current components among the pixels, and to reduce the granularity noise.

The image sensor method according to the present invention will now be described in detail with reference to FIG. 6. To acquire an image of one screen, the image pickup section 10i is first exposed to light. The exposure period E is controlled through the electronic shutter operation. In the electronic shutter operation, the clock pulses φi1 to φi3 to be applied to the transfer electrodes G1 to G3, which are located in the image pickup section 10i, are all set at the off-voltage V_{L2} for a predetermined period (t1 to t2). During this period, the substrate voltage Vsub is set at discharge voltage V_{SH}, which is higher than reference DC voltage V_{SL} as a DC voltage applied in a normal state. The reference DC voltage V_{SL} corresponds to the voltage at a point D in FIG. 5, and the discharge voltage V_{SH} corresponds to the voltage at a point D′ in FIG. 5. As a result, the information charges stored in the channel region in the image pickup section 10i are discharged to the rear surface of the substrate.

At time t2 when the electronic shutter operation ends, a clock signal of a given phase of the clock signal φi, for example, the clock signal φi2, changes in voltage from the voltage V_{L2} indicative of an off state to voltage V_{H} indicative of an on state. As a result, a potential well is formed under the transfer electrode G2. The exposure period E starts at this time. A time when the exposure period E ends are defined by time t18 at which the frame transfer starts.

Prior to the formation of the potential well starting at time t2, the transfer electrode G2 is applied the off-voltage V_{L2} in the electronic shutter operation (period: t1 to t2), and forms an inversion layer in the vicinity of the substrate surface under the transfer electrode. Since the interface state under the transfer electrode G2 captures holes during the period of applying the off-voltage V_{L2}, the dark current resulting from the interface state is reduced in a subsequent operation for accumulating the information charges into the potential well starts at time t2.

As described above, the position of the potential well during the exposure period E is shifted within the pixel. Following the potential well formation under the transfer electrode G2, a potential well is newly formed under the transfer electrode G1 (time t4). The information charges that have been stored under the transfer electrode G2 are moved into the new potential well under the transfer electrode G1, and information charges newly generated under the transfer electrode G1 are accumulated in the new potential well. Since the transfer electrode G1 was under the off-voltage voltage V_{L2} before the application of the on-voltage V_{H} at time t4, as with the accumulation of the information charges under the transfer electrode G2, the dark current is also reduced in the accumulation of the information charges under the transfer electrode G1. Subsequently, the position of the potential well will be successively shifted until the exposure period ends. In the potential well formation by any of the transfer electrodes, the off-voltage V_{L2} is pre-applied to the transfer electrode. In this way, dark current generation is suppressed in the accumulation of the information charges under each transfer electrode. As a result, the dark current component contained in the information charges accumulated in each pixel is reduced.

The information charges, which have been stored in the potential well under the last transfer electrode G3 during the exposure period E, are transferred to the storage section 10s at high speed in a frame transfer operation that starts at time t18. The clock generation circuit 12 generates high speed clock signals as the transfer clock signals φi (φi1 to φi3) and φs (φs1 to φs3) by cycles corresponding to the number of pixels arrayed in the column direction in the image pickup section 10i (period from times t18 to t19). The high-speed clock signals each have an amplitude defined between voltages V_{L1} and V_{H} and are synchronized with one another. In this way, the signal charges of all the pixels in the image pickup section 10i are transferred to the storage section 10s with the shielding film in a short time.

A clock cycle in the frame transfer is shorter than a period of switching between the on-voltage V_{H} and the off-voltage voltage V_{L2} during the exposure operation. No formation of the inversion layer is required for the high-speed transfer operation. In addition, if the amplitude of the clock signal is set at a large value, the leading time and the trailing time of the clock signal become larger and this results in difficulty of high-speed transfer. In view of these points related to high transfer speed, for the frame transfer, the voltage V_{L1} is used in place of the off-voltage V_{L2} to thereby reduce the amplitude of the clock signal. Also in the frame transfer, the frequency of the clock signal is extremely high, possibly creating problems of heat generation and power consumption. The amplitude reduction of the clock signal effectively suppresses the heat generation and the power consumption issues.

If the amplitude of the clock signal in the frame transfer is smaller than that during the exposure period, the amount of the information charges that are accumulated in the potential well during the exposure period E exceeds the amount of the information charges that the CCD shift registers can handle in the frame transfer. In this state, blooming tends to occur. To cope with this problem, the image pickup apparatus executes the blooming suppressing operation already stated prior to the frame transfer. Specifically, at time t17 prior to the start of the frame transfer (t18), discharge voltage V_{SH} is generated by superposing a pulse 72 on a reference DC voltage V_{SL} of the substrate voltage Vsub, and is applied to the substrate. As a result, the potential of the p-well 42 becomes a potential (point C′ in FIG. 5), which is deeper than a potential (point C in FIG. 5) in a normal state. An amount of information charges stored in the potential well, which exceed the potential (point C′ in FIG. 5) of the p-well 42, are discharged to the rear surface of the substrate. Thus, by reducing the amount of the information charges stored in the potential well before the frame transfer operation starts, blooming is unlikely to occur in the frame transfer operation.

When the potential well is shifted in the exposure period E, a potential barrier between the potential wells is formed by only one transfer electrode during a time period β when the transfer electrode from which the potential well is shifted, and the transfer electrode to which the potential well is shifted, simultaneously receive the on-voltage. Since the potential barrier lowers as described above, the blooming is apt to occur. To avoid this, the image pickup apparatus executes the blooming suppression operation. In an instance of FIG. 6, the pulse 70 is superposed on the reference DC voltage V_{SL} to generate the discharge voltage V_{SH}, and V_{SH} is applied to the substrate to thereby suppress the blooming (t3, t5, t7, t9, t11, t13 and t15) prior to each of times t4, t6, t8, t10, t12, t14, and t16 at which the duration β starts.

In the blooming suppression operation, blooming is suppressed by using the pulses 70 and 72 to be superposed on the substrate voltage Vsub. Due to this, the reference DC voltage V_{SL} may be determined independently of the blooming suppression. With the variation of the substrate voltage Vsub, the potential in the p-well 42 varies, and further the depth of the potential well (point B) from the substrate surface varies. Specifically, when the substrate voltage Vsub is decreased, the potential in the p-well 42 becomes shallow and the potential well moves to the substrate surface. As a result, the capacitance between the transfer electrodes 32 and the charge transfer channel increases, a potential variation of the channel to the transfer clock signal increases, and consequently the charge transfer capability increases. It is further noted that in the image pickup apparatus, blooming is suppressed by adjusting the discharge voltage V_{SH} of the pulses 70 and 72, and also the charge transfer capability required for the frame transfer and the line transfer in which the driving voltage amplitude is smaller than that in the exposure period is easily secured by setting the reference DC voltage V_{SL} to be low. In the embodiment, the substrate voltage Vsub for the pulse 70 and the substrate voltage Vsub when the electronic shutter operation is performed are both set at the discharge voltage V_{SH}, and equal to each other. If necessary, those voltages may be different from each other.

The information charges that have been transferred to the storage section 10s is transferred to the horizontal transfer section 10h through the line transfer. The clock generation circuit 12 generates a transfer clock signal φs of one cycle at times synchronized with a horizontal sync signal HD generated by the timing control circuit 14, and executes the line transfer process. The clock signals of the transfer clock signal φs for the line transfer each oscillate between the voltages from V_{L1} and V_{H}. The horizontal transfer section 10h transfers the information charges to the output section 10d by the horizontal transfer, and the output section 10d converts the information charges into an image signal Y0 (t), and outputs it sequentially.

The case where the potential well is shifted during the exposure period E has exemplarily been described. The dark current suppressing effect based on the interface state set up by the application of the off-voltage V_{L2} becomes weak with time after application of the on-voltage V_{H}. In this respect, the driving method in which the potential well is shifted updates the effect produced by applying the off-voltage V_{L2} at every movement of the potential well, to thereby effectively reduce the dark current component. Also, in the driving method in which the information charges are stored in the fixedly formed potential well in the exposure period E, the dark current can be reduced if the off-voltage V_{L2} is pre-applied.

As described above, a method of driving a solid-state image pickup device according to the present invention is applied to a solid-state image pickup device having an image pickup section, containing CCD shift registers, in which the CCD shift registers receive light and accumulate the information charges generated in response to the received light into the potential wells of the CCD shift registers. The driving method includes an exposure process for accumulating the information charges generated in response to the received light into each potential well, and a transfer process for driving the CCD shift registers by transfer clocks applied to read out the information charges from the image pickup section. The exposure process includes a accumulation process for applying an on-voltage to a storage electrode of transfer electrodes of the CCD shift registers, the storage electrode being one of the transfer electrodes and located corresponding to the accumulation position of the information charges to thereby form the potential well, and a pre-accumulation process for applying a pre-accumulation off-voltage, lower than an off-voltage of the transfer clock signal, to the storage electrode prior to the accumulation process.

In the invention, a density of free holes in the vicinity of the surface of the semiconductor substrate under the transfer electrode is increased by applying a pre-accumulation off-voltage, lower than an off-voltage of the transfer clock signal, to the storage electrode before a potential well for accumulating electrons as information charges is formed in an exposure operation.

In the driving method, the pre-accumulation off-voltage may take a value based on a pinning voltage forming an inversion layer in a semiconductor surface region under the transfer electrode.

The driving method may be applied to a solid-state image pickup device in which the CCD shift registers are of the buried channel type.

In the driving method which is applied to the solid-state image pickup device having a drain structure for discharging an unnecessary amount of the information charges from the charge transfer channel of the CCD shift registers in response to a discharge voltage applied, a discharge process for applying the discharge voltage to the drain structure prior to the transfer process to thereby discharge from the potential well surplus information charges which exceed a charge transfer capability of the CCD shift register, corresponding to the transfer clock signal, may be executed.

An image pickup apparatus according to the present invention has a solid-state image pickup device including an image pickup section, containing CCD shift registers, in which the CCD shift registers receive light and accumulate the information charges generated in response to the received light into the potential wells of the CCD shift registers, and a driving circuit for generating an on-voltage and off-voltages to be applied to the transfer electrodes of the CCD shift registers and controlling the formation and the shift of the potential well. The driving circuit generates an exposure off-voltage, which is lower than the off-voltage in a transfer operation to read out the information charges from the image pickup section by driving the CCD shift registers for transfer, as the off-voltage in an exposure operation for accumulating the information charges generated in response to the received light into the potential well. In the exposure operation, the driving circuit applies the exposure off-voltage to the transfer electrode prior to applying the on-voltage to the transfer electrode to form the potential well.

A low off-voltage (pre-accumulation off-voltage) is applied before the information charges are accumulated in the exposure operation to increase a density of free holes in the vicinity of the surface of the substrate. As a result, the rate of capturing holes is high at an interface state produced at an interface between the substrate and the gate oxide film. Therefore, subsequently, in the process of accumulating the information charges into the potential well formed by the application of the on-voltage, the electrons that have been excited from the valence band to the interface state capture holes and easily return to the valance band. In other words, electrons in the valence band become difficult to be excited to the conduction band via interface state, so that the dark current decreases. In the transfer operation, the off-voltage is higher than the pre-accumulation off-voltage. As a result, a potential in the charge transfer channel changes quickly following the switching between the on-voltage and the off-voltage, and a high speed transfer is realized. Furthermore the high off-voltage reduces the power consumption in the transfer operation.

What is claimed is:

1. A driving method for a solid-state image pickup device having an image pickup section, containing CCD shift registers, in which the CCD shift registers receive light and accumulate information charges generated in response to the received light into potential wells of the CCD shift registers, the driving method comprising: an exposure process for accumulating the information charges generated in response to the received light into each of the potential wells; and a transfer process for driving the CCD shift registers by transfer clocks applied to read out the information charges from the image pickup section, wherein the exposure process includes a accumulation process for applying an on-voltage to a storage electrode of transfer electrodes of the CCD shift registers, the storage electrode being one of the transfer electrodes and located corresponding to the accumulation position of the information charges to thereby form the potential well, and a pre-accumulation process for applying a pre-accumulation off-voltage, lower than an off-voltage of the transfer clock signal to the storage electrode prior to the accumulation process.

2. The driving method according to claim 1, wherein the pre-accumulation off-voltage takes a value based on a pinning voltage forming an inversion layer in a semiconductor surface region under the transfer electrode.

3. The driving method according to claim 1, wherein the CCD shift registers are of the buried channel type.

4. The driving method according to claim 1, wherein the solid-state image pickup device has a drain structure for discharging an unnecessary amount of the information charges from charge transfer channel regions of the CCD shift registers in response to a discharge voltage applied, and the driving method includes a discharge process for applying the discharge voltage to the drain structure prior to the transfer process to thereby discharge from the potential well surplus information charges which exceed a charge transfer capability of the CCD shift register, corresponding to the transfer clock signal.

5. An image pickup apparatus having a solid-state image pickup device including an image pickup section, containing CCD shift registers, in which the CCD shift registers receive light and accumulate information charges generated in response to the received light into potential wells of the CCD shift registers, and a driving circuit for generating an on-voltage and off-voltages to be applied to transfer electrodes of the CCD shift registers and controlling formation and shift of the potential well, wherein the driving circuit generates an exposure off-voltage, which is lower than the off-voltage in a transfer operation to read out the information charges from the image pickup section by driving the CCD shift registers for transfer, as the off-voltage in an exposure operation for accumulating the information charges generated in response to the received light into the potential well, and applies the exposure off-voltage to the transfer electrode prior to applying the on-voltage to the transfer electrode in the exposure operation to form the potential well.
